(19) United States
(12) Patent Application Publication
(10) Pub. No.: US 2006/0040166 A1
(43) Pub. Date: Feb. 23, 2006

(54) Fuel cell side plates with controlled tensile compliance

(76) Inventors: Michael K. Budinski, Pittsford, NY (US); Daniel Miller, Victor, NY (US); Yeh-Hung Lai, Webster, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 10/920,657

(22) Filed: Aug. 18, 2004

(51) Int. Cl. H01M 8/02; H01M 8/10

(52) U.S. Cl. 429/37; 429/32

(57) ABSTRACT

A device configured to convert a hydrogenous fuel source to electrical energy is provided, the device comprising an electrochemical conversion assembly compressively loaded along a loading axis of the conversion assembly and at least one side plate. The side plate includes a proximal end, a distal end, and at least one spring element positioned between the proximal end and the distal end. The spring element is configured to maintain the compressive loading along the loading axis of the electrochemical conversion assembly. The device can further comprise a fuel cell, and the device can further comprises structure defining a vehicle powered by the fuel cell.

### BACKGROUND OF THE INVENTION

The present invention relates to the design and manufacture of devices configured to convert a hydrogenous fuel source to electrical energy and, more particularly, to fuel cell side plates with controlled tensile compliance.

### BRIEF SUMMARY OF THE INVENTION

Proton Exchange Membrane (PEM) fuel cell stacks are typically loaded in compression in order to maintain low interfacial electrical contact resistance between the bipolar plates, the gas diffusion media, and the catalyst electrode. The low interfacial contact resistance in a PEM fuel cell stack is directly related to the compression load. Typically, compression loads on the bipolar plate range from about 50 to about 400 psi.

The present invention provides a fuel cell side plate with controlled tensile compliance. By incorporating at least one spring element into the side plate, the compression forces on the fuel cell stack can be controlled. Compressive spring forces may offset the strains in the fuel cell caused by membrane swelling, compressive stress or creep relaxation, dimensional variation, and thermal expansion and contraction, in order to maintain a relatively constant compressive load in the fuel cell stack.

Although the present invention is not limited to specific advantages or functionality, it is noted that the spring element is designed in a manner such that the side plate is effective in controlling the compressive loads in the fuel cell stack, and will offset strains produced by membrane swelling and compressive stress relaxation. Also, the spring element acts to reduce the over-compression and damage of gas diffusion media in the fuel cell stack, as well as maintain the stack compression and contact pressure between bipolar plates, gas diffusion media, and catalyst layers. In addition, the spring element provides flexibility in fine-tuning the stack compression by adjusting the pre-stretch. By integrating the spring element into the side plate, the present invention provides improved packaging and increased volumetric and gravimetric power density. Moreover, stamping and other forming processes enable fabrication of low-cost spring elements conducive of automobile production requirements and allow the formation of spring element shapes that can accurately control the required force-deflection response to offset the deleterious effects of membrane swelling and compressive stress relaxation.

In accordance with one particular embodiment of the present invention, a device configured to convert a hydrogenous fuel source to electrical energy is provided comprising an electrochemical conversion assembly and at least one side plate. The electrochemical conversion assembly is compressively loaded along a loading axis of the conversion assembly. The side plate includes a proximal end, a distal end, and at least one spring element positioned between the proximal end and the distal end. The spring element is configured to maintain the compressive loading along the loading axis of the electrochemical conversion assembly.

In accordance with another embodiment of the present invention, a device configured to convert a hydrogenous fuel source to electrical energy is provided comprising first and second end plates, an electrochemical conversion assembly compressively loaded along a loading axis of the conversion assembly and positioned between the first and second end plates, and at least one side plate secured to the first and second end plates. The side plate includes a proximal end, a distal end, and at least one spring element positioned between the proximal end and the distal end. The spring element is configured to maintain the compressive loading along the loading axis of the electrochemical conversion assembly, which electrochemical conversion assembly comprises one or more bipolar plates, gas diffusion media, and polymer membrane. The spring element is configured to maintain contact pressure between the bipolar plates, gas diffusion media, and polymer membrane in response to a change in thickness of the electrochemical conversion assembly. The change in thickness can be the result of swelling of the polymer membrane or compressive deformation of the diffusion media.

These and other features and advantages of the invention will be more fully understood from the following detailed description of the invention taken together with the accompanying claims. It is noted that the scope of the claims is defined by the recitations therein and not by the specific discussion of features and advantages set forth in the present description.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is a schematic illustration of a vehicle incorporating a fuel cell in accordance with the principals of the present invention.

FIG. 2 is a perspective view of a side plate including at least one spring element that is configured to maintain compressive loading along a loading axis of an electrochemical conversion assembly in accordance with the principals of one embodiment of the present invention;

FIG. 3 is a perspective view of an electrochemical conversion assembly and side plate, which side plate includes at least one spring element that is configured to maintain compressive loading along a loading axis of the electrochemical conversion assembly in accordance with the principals of one embodiment of the present invention;

FIG. 4 is a side view of a side plate including a plurality of spring elements that are configured to maintain compressive loading along a loading axis of an electrochemical conversion assembly in accordance with the principals of another embodiment of the present invention; and

FIG. 5 is a perspective view of an electrochemical conversion assembly and side plate, which side plate includes a plurality of spring elements that are configured to maintain compressive loading along a loading axis of the electrochemical conversion assembly in accordance with the principals of another embodiment of the present invention.

Artisans practicing the present invention will appreciate that elements in the figures are illustrated for simplicity and clarity and have not necessarily been drawn to scale. For example, the dimensions of some of the elements in the figures may be exaggerated relative to other elements to help improve understanding of embodiment(s) of the present invention.

### DETAILED DESCRIPTION OF SOME EMBODIMENTS OF THE INVENTION

Through the analysis of the compression aspects of fuel cell stacks, it is noted that the thickness of polymer membranes such as, for example, Gore 5510 series (available from W. L. Gore & Associates, Inc., Newark, Del.) or DuPont™ Nafion® PFSA NR-111 (available from DuPont, Wilmington, Del.) swells as much as 40% when exposed to the water present in operating fuel cells. Because fuel cell stacks are typically assembled and compressed in the dry condition, when the membranes swell during fuel cell operation, the swelling strain can initially increase the internal compression load on the stack. However, the higher compression forces produced by swelled membranes can cause the diffusion media to undergo permanent compression deformation (e.g., the diffusion media is permanently crushed). After a number of cycles, the compression load inside the fuel cell can be substantially reduced because of this effect. Additionally, viscoelastic creep in the membrane can also reduce the compressive load via compressive stress relaxation—further reducing the compressive load in the fuel cell. As a result, the lower compressive load causes an increase in the internal resistance of the fuel cell, lowering fuel cell efficiency.

Spring force can be used to control the compressive force within an electrochemical conversion assembly and therefore mitigate the effects of compression creep and permanent set of the diffusion media. Through design, it is possible to control the force-deflection response of spring elements within a side plate and, therefore, maintain compressive force within the electrochemical conversion assembly.

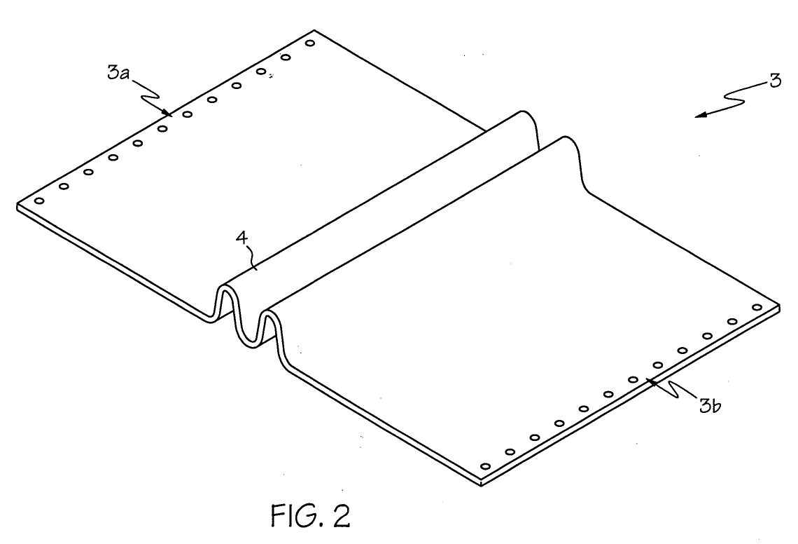

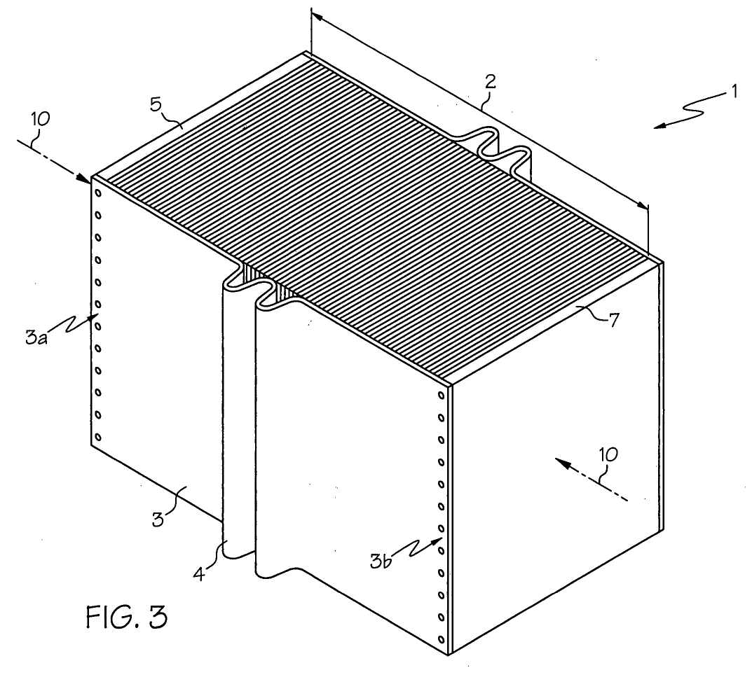

Referring now to FIGS. 2 and 3, in accordance with one embodiment of the present invention, a device 1 configured to convert a hydrogenous fuel source to electrical energy is provided comprising an electrochemical conversion assembly 2 and at least one side plate 3. The electrochemical conversion assembly 2 is compressively loaded along a loading axis 10. The side plate 3 includes a proximal end 3a, a distal end 3b, and at least one spring element 4 positioned between the proximal end 3a and the distal end 3b. The spring element 4 is configured to maintain the compressive loading along the loading axis 10 of the electrochemical conversion assembly 2. In addition, the side plate 3 can be oriented parallel to the loading axis 10 and, as such, the spring element 4 is oriented parallel to the loading axis 10.

As shown in FIG. 3, the device 1 typically further comprises a pair of end plates 5, 7 with the electrochemical conversion assembly 2 positioned there between. In accordance with the present invention, the side plate 3 is secured to the first and second end plates 5 and 7 at the proximal and distal ends 3a, 3b, respectively. The device 1 can further comprise a plurality of side plates 3, which can be oriented on opposite sides of the loading axis 10. The side plates 3 can be secured to the first and second end plates 5 and 7 by any suitable means.

As will be appreciated by those skilled in the art, the device 1 can further comprise insulation layers and current collector/conductor plates (not shown), with the electrochemical conversion assembly 2 positioned therebetween. By connecting an external load between electrical contacts of current collector/conductor plates, one can complete a circuit for use of current generated by the electrochemical conversion assembly 2. The device 1 can also further comprise fluid manifolds for supplying fluids to, removing fluids from, and otherwise communicating and/or servicing fluids as desired within the electrochemical conversion assembly 2.

The side plate 3 and spring element 4 can each comprise a metallic alloy such as steel. The spring element 4 should be designed so that it can maintain sufficient compressive loading along the loading axis 10 of the electrochemical conversion assembly 2. For example, the spring constant of the side plate 3 should be significantly less than a flat steel side plate held in tension.

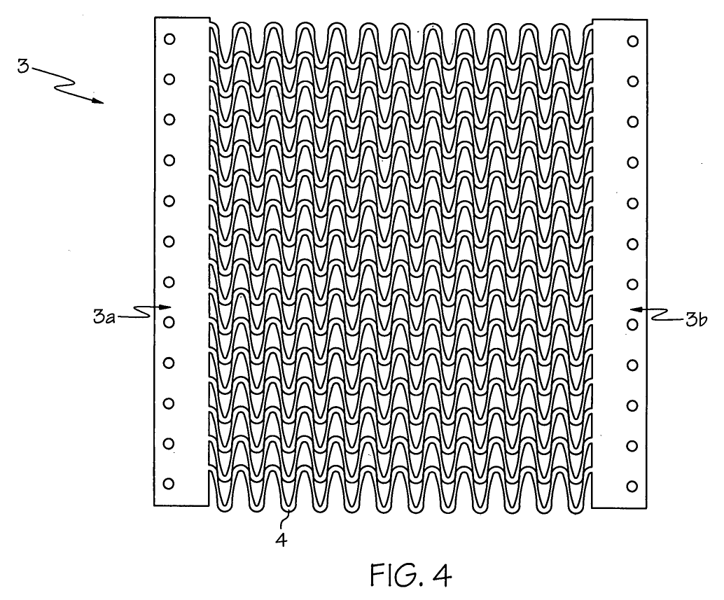

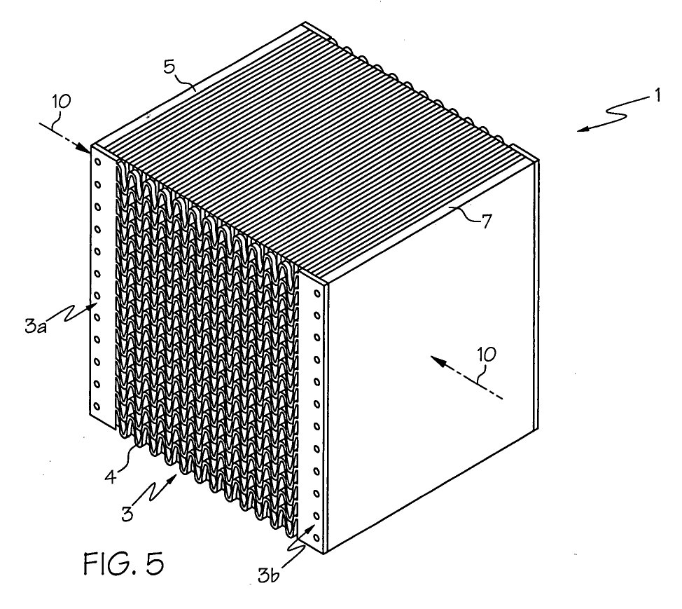

As shown in FIGS. 4 and 5, the side plate 3 can further include a plurality of spring elements 4, which spring elements 4 can be stamped into the side plate 3 using metal stamping methods that are well known to those skilled in the art. Optionally, the spring elements 4 can be formed in the side plate 3 by cutting or otherwise perforating a spring-like pattern in the sheet metal that forms the side plate 3.

The one or more spring elements 4 that are formed within the side plate 3 are configured to expand and contract in response to a change in thickness of the electrochemical conversion assembly 2. More particularly, the electrochemical conversion assembly 2 can comprise one or more bipolar plates, gas diffusion media, and polymer membrane, and the spring element 4 is configured to maintain contact pressure between the bipolar plates, gas diffusion media, and polymer membrane in response to a change in thickness of the electrochemical conversion assembly 2. The polymer membrane can comprise a proton exchange membrane, and the change in thickness of the electrochemical conversion assembly 2 can be caused by swelling of the polymer membrane or compressive deformation of the diffusion media.

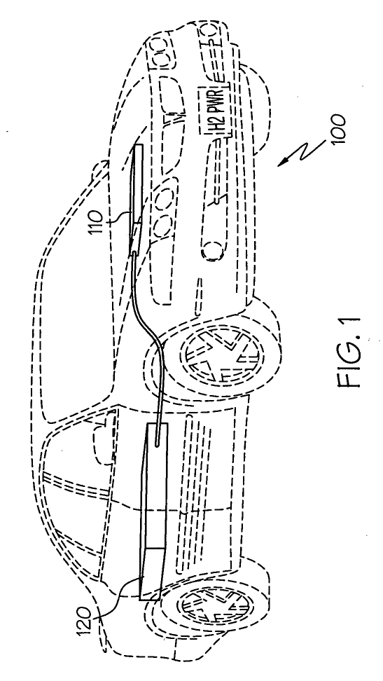

Referring now to FIG. 1, a fuel cell system incorporating at least one side plate according to the present invention may be configured to operate as a source of power for a vehicle 100. Specifically, fuel from a fuel storage unit 120 may be directed to the fuel cell assembly 110 configured to convert fuel, e.g., H₂, into electricity. The electricity generated is used as a motive power supply for the vehicle 100 where the electricity is converted to torque and vehicle translational motion. Although the vehicle 100 shown in FIG. 1 is a passenger automobile, it is contemplated that the vehicle 100 can be any vehicle now known or later developed that is capable of being powered or propelled by a fuel cell system, such as, for example, automobiles (i.e., car, light- or heavy-duty truck, or tractor trailer), farm equipment, aircraft, watercraft, railroad engines, etc.

It is noted that terms like “preferably”, “commonly” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For example, a “device” according to the present invention may comprise a diffusion media, a fuel cell incorporating a diffusion media according to the present invention, a vehicle incorporating a fuel cell according to the present invention, etc.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A device configured to convert a hydrogenous fuel source to electrical energy, said device comprising:
an electrochemical conversion assembly compressively loaded along a loading axis of said conversion assembly; and
at least one side plate, wherein
said side plate includes a proximal end and a distal end,
said side plate includes at least one spring element positioned between said proximal end and said distal end, and
said spring element is configured to maintain said compressive loading along said loading axis of said electrochemical conversion assembly.

2. The device of claim 1 further comprising first and second end plates, wherein
said electrochemical conversion assembly is positioned between said first and said second end plates, and
said side plate is secured to said first and said second end plates.

3. The device of claim 1 further comprising a plurality of said side plates.

4. The device of claim 3 wherein said side plates are oriented on opposite sides of said loading axis.

5. The device of claim 1 wherein said side plate is oriented parallel to said loading axis.

6. The device of claim 1 wherein said spring element is oriented parallel to said loading axis.

7. The device of claim 1 wherein said side plate and said spring element comprise a metallic alloy.

8. The device of claim 7 wherein said metallic alloy comprises steel.

9. The device of claim 1 wherein said side plate includes a plurality of said spring elements.

10. The device of claim 1 wherein said side plate is stamped or cut to form said spring element.

11. The device of claim 1 wherein said spring element is configured to expand and contract in response to a change in thickness of said electrochemical conversion assembly.

12. The device of claim 1 wherein said electrochemical conversion assembly comprises one or more bipolar plates, gas diffusion media, and polymer membrane, and wherein said spring element is configured to maintain contact pressure between said bipolar plates, gas diffusion media, and polymer membrane in response to a change in thickness of said electrochemical conversion assembly.

13. The device of claim 12 wherein said polymer membrane comprises a proton exchange membrane.

14. The device of claim 12 wherein said change in thickness is caused by swelling of said polymer membrane.

15. The device of claim 12 wherein said change in thickness is caused by compressive deformation of said diffusion media.

16. The device of claim 1 wherein said device comprises a fuel cell.

17. The device of claim 16 wherein said device further comprises structure defining a vehicle powered by said fuel cell.

18. A device configured to convert a hydrogenous fuel source to electrical energy, said device comprising:
first and second end plates;
an electrochemical conversion assembly compressively loaded along a loading axis of said conversion assembly and positioned between said first and second end plates; and
at least one side plate secured to said first and second end plates, wherein
said side plate includes a proximal end and a distal end,
said side plate includes at least one spring element positioned between said proximal end and said distal end,
said spring element is configured to maintain said compressive loading along said loading axis of said electrochemical conversion assembly,
said electrochemical conversion assembly comprises one or more bipolar plates, gas diffusion media, and polymer membrane,
said spring element is configured to maintain contact pressure between said bipolar plates, gas diffusion media, and polymer membrane in response to a change in thickness of said electrochemical conversion assembly, and
said change in thickness is caused by swelling of said polymer membrane or compressive deformation of said diffusion media.

19. A device configured to convert a hydrogenous fuel source to electrical energy, said device comprising:
first and second end plates;
an electrochemical conversion assembly compressively loaded along a loading axis of said conversion assembly and positioned between said first and second end plates; and
at least one side plate oriented parallel to said loading axis and secured to said first and second end plates, wherein
said side plate includes a proximal end and a distal end,
said side plate includes at least one spring element oriented parallel to said loading axis and positioned between said proximal end and said distal end,
said spring element is configured to maintain said compressive loading along said loading axis of said electrochemical conversion assembly,
said side plate is stamped or cut to form said spring element,
said side plate and said spring element comprise a metallic alloy,
said electrochemical conversion assembly comprises one or more bipolar plates, gas diffusion media, and proton exchange membrane,
said spring element is configured to maintain contact pressure between said bipolar plates, gas diffusion media, and proton exchange membrane in response to a change in thickness of said electrochemical conversion assembly, and
said change in thickness is caused by swelling of said proton exchange membrane or compressive deformation of said diffusion media.
